(19) United States
(12) Patent Application Publication
(10) Pub. No.: US 2010/0113042 A1
(43) Pub. Date: May 6, 2010

(54) WIRELESS NETWORK DISCOVERY

(75) Inventors: Mika KASSLIN, Espoo (FI); Harald KAAJA, Jarvenpaa (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/264,748

(22) Filed: Nov. 4, 2008

(51) Int. Cl. H04W 72/00; H04M 1/00

(52) U.S. Cl. 455/450; 455/550.1

(57) ABSTRACT

The example embodiments may delay initiation of channel access procedure for transmitting a network discovery message to a network potentially employing directional communication between at least some of the nodes in the network, until a threshold for channel access initiation is met. Meeting the threshold includes satisfying at least one of the following criteria conditions: detecting no activity for at least a predetermined duration of time, or receiving a frame indicating a closure time of a directional communication in the network, or receiving a frame indicating a starting time of an omnidirectional communication period in the network. After meeting at least one of the threshold criteria conditions, the example embodiments may initiate the channel access procedure.

### FIELD

The present invention relates to wireless communication and more particularly to discovery and detection of wireless communication networks.

### BACKGROUND

Modem society has quickly adopted, and become reliant upon, handheld devices for wireless communication. For example, cellular telephones continue to proliferate in the global marketplace due to technological improvements in both the communication quality and device functionality. These wireless communication devices have become common for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate wireless communication over large geographic areas. These network technologies have commonly been divided by generations, starting in the late 1970s to early 1980s with first generation (1G) analog cellular telephones that provided baseline voice communication, to modern digital cellular telephones. Global System for Mobile Communications (GSM) is an example of a widely employed 2G digital cellular network communicating in the 900 MHz/1.8 GHz bands in Europe and at 850 MHz and 1.9 GHz in the United States. This network provides voice communication and also supports the transmission of textual data via the Short Messaging Service (SMS). SMS allows a wireless communications device (WCD) to transmit and receive text messages of up to 160 characters, while providing data transfer to packet networks, Integrated Services Digital Network (ISDN) and Plain Old Telephone Service (POTS) users at 9.6 Kbps. The Multimedia Messaging Service (MMS), an enhanced messaging system allowing for the transmission of sound, graphics and video files in addition to simple text, has also become available in certain devices. Soon, emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth™ is an example of a short-range wireless technology quickly gaining acceptance in the marketplace. A 1 Mbps Bluetooth™ radio may transmit and receive data at a rate of 720 Kbps within a range of 10 meters, and may transmit up to 100 meters with additional power boosting. Enhanced Data Rate (EDR) technology, which is also available, may enable maximum asymmetric data rates of 1448 Kbps for a 2 Mbps connection and 2178 Kbps for a 3 Mbps connection. In addition to Bluetooth™, other popular short-range wireless networks include for example IEEE 802.11 Wireless LAN, Wireless Universal Serial Bus (WUSB), Ultra Wideband (UWB), ZigBee (IEEE 802.15.4 and IEEE 802.15.4a), wherein each of these exemplary wireless mediums have features and advantages that make them appropriate for various applications The IEEE 802.11 Wireless LAN Standard defines one common medium access control (MAC) specification and includes several over-the-air modulation techniques that all use the same basic MAC protocol. The 802.11a standard operates in 5 GHz band, and uses orthogonal frequency-division multiplexing (OFDM) with a maximum data rate of 54 Mbit/s. The 802.11b standard uses the 2.4 GHz band and direct sequence spread spectrum (DSSS) modulation to deliver up to 11 Mbps data rates. The 802.11g standard uses the 2.4 GHz band, and builds on top of the 802.11b standard providing data rates up to 54 Mbps with OFDM based modes similar to the ones in 802.11a. The radiation pattern for IEEE 802.11a, b, and g devices is omnidirectional, wherein power is radiated uniformly in a plane. The IEEE 802.11a, b, and g standard is now referred to as clause 17 PHY, clause 18 PHY or clause 19 PHY of the IEEE 802.11-2007 standard.

The IEEE 802.11 Wireless LAN Standards describe two major components, a wireless device, called a station (STA), and a fixed access point (AP) wireless device. The AP may perform the wireless-to-wired bridging from STAs to a wired network. The basic network is the basic service set (BSS), which is a group of wireless devices that communicate with each other. An infrastructure BSS is a network that has an AP as an essential node.

IEEE 802.11 medium access control (MAC) protocol regulates access to the RF physical link. The MAC provides a basic access mechanism with clear channel assessment, channel synchronization, and collision avoidance using the Carrier sense Multiple Access (CSMA) principle. It also provides network inquiring, which is an inquiry and scan operation. The MAC provides link setup, data fragmentation, authentication, encryption, and power management.

Synchronization is the process of the stations in an IEEE 802.11 network getting in step with each other, so that reliable communication is possible. The MAC provides the synchronization mechanism to allow support of physical layers that make use of frequency hopping or other time-based mechanisms where the parameters of the physical layer change with time. The process involves beaconing to announce the presence of a network and inquiring to find a network. Once a network is found, a station joins the network.

In an IEEE 802.11 infrastructure network, access points periodically send beacons to announce their presence and relay information to mobile stations within range. The mobile stations scan 802.11 channels and listen for beacons as the basis for selecting an access point and its infrastructure network.

In an IEEE 802.11 ad hoc network, there is no access point (AP) to act as the central time source for the ad hoc network. Since there is no AP, the mobile station that starts the ad hoc network will begin by transmitting a Beacon, choosing a beacon period. This establishes the basic beaconing process for this ad hoc network. After the ad hoc network has been established, each station in the ad hoc network will attempt to send a Beacon after the target beacon transmission time arrives. To minimize actual collisions of the transmitted Beacon frames on the medium, each station in the ad hoc network will choose a random delay value, which it will allow to expire before it attempts its Beacon transmission. If the station receives a beacon from another station in the network when waiting for the delay to expire, it will not transmit its own beacon.

In order for an apparatus to communicate with other apparatuses in a wireless network, it must first find the other apparatuses. The process of finding another apparatus may involve either by passive scanning or active scanning. Passive scanning involves only listening for example for IEEE 802.11 traffic. Active scanning requires the inquiring apparatus to transmit and invoke responses from IEEE 802.11 apparatuses.

### SUMMARY

Method, apparatus, and computer program product embodiments are disclosed for wireless networks, to enable an appropriate delay to occur before initiation of channel access procedure for transmitting a network discovery message to a network potentially employing directional communication. An active scanning procedure is disclosed that enables scanning devices using omnidirectional radiation patterns to search for networks that are using directional radiation patterns. This ensures that the device performing active omnidirectional scanning does not create unnecessary collisions with existing directional communication links. Moreover, since network discovery messages are timed to occur when the directional communication link is quiescent, nodes in the directional network are able to detect an omnidirectional network discovery message and respond to it accordingly.

The example embodiments may delay initiation of channel access procedure for transmitting a network discovery message to a network potentially employing directional communication between at least some of the nodes in the network, until a threshold for channel access initiation is met. Meeting the threshold includes satisfying at least one of the following criteria conditions:
detecting no activity for at least a predetermined duration of time, wherein the predetermined duration of time is based on a maximum duration of time allowed for a continuous directional communication sequence in a directional network; or
receiving a frame indicating a closure time of a directional communication in the network; or
receiving a frame indicating a starting time of an omnidirectional communication period in the network.

After meeting at least one of the threshold criteria conditions, the example embodiments may initiate the channel access procedure for transmitting the network discovery message to the network based at least partly on the satisfied criteria condition for meeting the threshold.

The example waiting time to detect activity may also be longer than the maximum possible/allowed duration of a continuous directional communication sequence.

The example scanning device is not allowed to perform any access procedure until the occurrence of meeting the threshold satisfying at least one of the criteria conditions.

The embodiments include example frames indicating a closure time of a directed communication period or a starting time of an omnidirectional communication period. For example, the detection of a beacon transmission or a contention-free end frame may be considered as the starting point of omnidirectional communication. In example embodiments, the detection of a request to send (RTS) frame or a clear to send (CTS) frame may indicate the beginning of a directional link, wherein the RTS and CTS frames may also include an indication when the directional link ends and, thereafter, when the omnidirectional period is about to start.

### DESCRIPTION OF THE FIGURES

FIG. 1A illustrates an external view and a functional block diagram of an example embodiment of a mobile wireless device and a wireless access point network, wherein the mobile device does not detect the ongoing directional radiation pattern of the access point and mistakenly begins omnidirectional transmission of its probe request, thereby causing a collision condition.

FIG. 1B illustrates the external view and functional block diagram of FIG. 1A, wherein the wireless access point sends an example omnidirectional transmission of frame 150A indicating the closure time of a directed communication period according to at least one embodiment of the invention.

FIG. 1C illustrates the external view and functional block diagram of FIG. 1A, wherein the wireless access point sends an example omnidirectional transmission of frame 150B indicating the starting time of an omnidirectional communication period according to at least one embodiment.

FIG. 1D illustrates the external view and functional block diagram of FIG. 1A, wherein the wireless access point sends an example omnidirectional transmission of a request to send (RTS) frame 150C indicating the duration of a frame (or a sequence of frames) it is requesting to send to the mobile wireless device 170 during a directional communication period according to at least one embodiment. During the requested and granted time one can send any number of frames.

FIG. 1E illustrates the external view and functional block diagram of FIG. 1A, wherein the mobile wireless device 170 sends an example omnidirectional transmission of a clear to send (CTS) frame 170A indicating the duration of the frame (or the sequence of frames) the access point 150 has requested to send to the mobile wireless device 170 during the directional communication period according to at least one embodiment.

FIG. 2 is a flow diagram of an example embodiment for the mobile wireless device performing the active scanning procedure, wherein the scanning device is prevented from starting omnidirectional contention for the probe request transmission until one of three conditions are met: either no activity has been detected in the channel for the maximum possible/allowed duration of a continuous directional communication sequence, or there is a receipt of the closure time frame 150A, or there is a receipt of the starting time frame 150B.

FIG. 3A is an example format for a beacon frame as the closure time frame 150A according to at least one embodiment.

FIG. 3B is an example format for a beacon frame as the starting time frame 150B according to at least one embodiment of the invention.

FIG. 4A is an example format for a control frame sent by the wireless access point as an example omnidirectional transmission of a request to send (RTS) frame 150C indicating the duration of a frame (or a sequence of frames) it is requesting to send as a directional transmission to the mobile wireless device 170 during a directional communication period according to at least one embodiment.

FIG. 4B is an example format for a control frame sent by the mobile wireless device 170 as an example omnidirectional transmission of a clear to send (CTS) frame 170A indicating the duration of the frame (or the sequence of frames) the access point 150 has requested to send as a directional transmission to the mobile wireless device 170 during the directional communication period according to at least one embodiment.

### DISCUSSION OF EXAMPLE EMBODIMENTS OF THE INVENTION

While the present invention has been described below embodied in terms of one or more implementation examples, various changes can be made therein without departing from the spirit and scope of the invention, as described in the appended claims.

As previously set forth, the present invention, in accordance with at least one embodiment, may be implemented utilizing a variety of apparatuses. Therefore, establishing an understanding of wirelessly-enabled apparatuses that may be used in implementing these various example embodiments may aid in comprehending the following disclosure. For example, in the case of a cellular handset, palmtop or laptop computer, wireless communicator or other handheld wireless apparatus, the integrated data handling capabilities of the apparatus may play an important role in facilitating transactions between the transmitting and receiving apparatuses.

Active scanning allows an apparatus to find a network while minimizing the time spent inquiring. The apparatus may perform this by actively transmitting queries that invoke responses from stations in a network. In an active inquiry, the apparatus may move to a particular channel and transmit a network discovery message. The responding device in the network may respond by sending a response message to the inquiring apparatus. This response message may include the information necessary for the inquiring apparatus to extract a description of the network. The inquiring apparatus may also process any other received response messages and other general transmissions relating to a configuration of the network, such as, for example Beacon frames. Once the inquiring apparatus has processed any responses, or has decided that there will be no responses, it may change to another channel and repeat the process. At the conclusion of the inquiry, the apparatus has accumulated information about the networks in its vicinity.

An IEEE 802.11 Wireless LAN (WLAN) station or terminal that is looking for available WLAN networks may perform scanning either in active or passive manner. In active scanning the terminal transmits probe request frames and waits for replies in form of probe responses from access points (APs) (or devices in ad hoc networks) that are responsible for replying to the request as per the probe response transmission rules. For the probe request transmissions there are some rules to minimize the probability of collisions with other transmissions in the channel. A terminal that comes into a WLAN channel for active scanning doesn't typically know anything about the channel operations; it doesn't know whether there is a WLAN network and it doesn't know whether there is some ongoing transmission. Thus, the terminal that comes to the channel for active scanning may try to time its probe request transmission so that it doesn't collide with any ongoing transmission of a WLAN network. This kind of timing ensures also that the possible AP (or a terminal that has beaconed in ad hoc network) can detect the probe request and is not in the middle of some other transmission sequence. Lack of probe responses are interpreted in scanning terminal as lack of a WLAN network the terminal was scanning.

Currently in the IEEE 802.11-2007 WLAN standard where the radiation pattern is omnidirectional, the rules are relatively simple and straightforward, since all the transmissions from the beaconing device (e.g. AP) have the same coverage. Before the terminal can start channel access for a probe request transmission, it will wait for a certain time (in the range of few tens of microseconds) unless it detects some activity in the channel. Channel access will start either upon the timer expiry or activity detection, whichever happens first. The IEEE 802.11-2007 Wireless LAN Standard is published by the Institute of Electrical and Electronics Engineers, Inc.

However, when the radiation pattern of a network is directional, the rules may need to change for a scanning device to wait before starting channel access by transmitting a network discovery message, such as, for example an omnidirectional probe request. When the frequency of the operating band is increased to 60 GHz the millimeter wavelengths impose a directionality to the radiated pattern. When the station or terminal approaches an infrastructure network operating at a 60 GHz channel, there may be an access point or like in the WLAN infrastructure network currently communicating with another terminal using a directional link. If the scanning terminal happens to be outside the coverage area of the directional link, it doesn't sense anything happening in the channel. The duration of transmission sequences may be relatively long between devices. The combination of directionality of the radiation pattern and the length of the transmissions means that 60 GHz one communication event may take tens of milliseconds over a directional link. If a terminal approaches a network during that time period to perform active scanning, it may not sense the ongoing communication. If it transmits its probe request during the ongoing transmission of the directional link, a collision condition may occur. In addition to the possible collision, this may lead to a situation that the AP may not detect the probe request and doesn't reply to it with a probe response. Consequently, since the terminal does not detect a probe response, the terminal may think that there is no network and proceeds to other channels.

The example embodiments disclosed herein are related to the 60 GHz version of the IEEE 802.11 WLAN. Two related standardization activities have been started or are about to be started: a) NGmS (next generation millimeter wave standardization), b) VHT WLAN (very high throughput WLAN). Their objective is to provide a means for WLANs to have bit rates in the range of few Gbps. At the 60 GHz band, this implies using of directional links. The 60 GHz frequency band propagation characteristics are such that directionality is required to obtain Gbps data rates over links a few meters long. Directionality means in practice that the coverage area of the transmissions is limited compared to omnidirectional transmissions of the clause 17 PHY, clause 18 PHY or clause 19 PHY of the IEEE 802.11-2007 standard. In the infrastructure WLAN case, this means that not all of the access point (AP) transmissions can be heard by mobile stations or terminals that are in the AP's coverage area.

The present invention, in accordance with various example embodiments, may be implemented with any communication configuration enabled to operate, for example, in a manner similar to the above identified communication mediums. While various IEEE 802.11 technologies will be used for the sake of explanation in the following disclosure, as previously set forth, the following example embodiments of the present invention are not specifically limited to any of the above mentioned wireless communication mediums, but the example embodiments are intended to be applicable to any other imaginable wireless communication technologies that involve directional communication technique among at least some nodes of a network.

When a terminal using omnidirectional radiation patterns is about to initiate communication over a communications band that uses directional communication, e.g. the 60 GHz band, it is likely that there are networks present that are potentially employing directional communication. The example embodiments disclosed herein enable a terminal to modify its operation according to the particular characteristics of the environment and implement rules that are designed for situations where directional networks are expected to be encountered.

The example embodiments disclosed herein enable a terminal to have an appropriate delay before starting channel access and then transmitting a network discovery message, such as, for example an omnidirectional probe request in a wireless network having a directional radiation pattern. An active scanning procedure is disclosed that enables scanning devices using omnidirectional radiation patterns to search for networks that are using directional radiation patterns. This ensures that the device performing active omnidirectional scanning does not create unnecessary collisions with existing directional communication links. Moreover, devices currently engaging in directional communication are able to detect the omnidirectional probe request and respond to it accordingly.

The example embodiments prevent a scanning device from starting omnidirectional contention for the probe request transmission until either:

a) No activity has been detected in the channel for the maximum possible/allowed duration of a continuous directional communication sequence; or

b) A frame is received indicating the closure time of a directed communication period (i.e. virtual carrier sensing commenced); or

c) A frame is received indicating the starting time of an omnidirectional communication period (i.e. virtual carrier sensing commenced).

The example waiting time to detect activity may also be longer than the maximum possible/allowed duration of a continuous directional communication sequence.

The example scanning device is not allowed to perform any access procedure until after the occurrence one of the three above-mentioned events. Especially in connection with the above rules b) and c), the apparatus is allowed to initiate channel access procedures after the indicated time, i.e., after an interval following the closure time indicated in the closure time frame of rule b) or after an interval following the starting time indicated in the starting time frame of rule c).

The embodiments include example frames indicating a closure time of a directed communication period or a starting time of an omnidirectional communication period. For example, the detection of a beacon transmission or a contention-free end frame may be considered as the starting point of omnidirectional communication. In example embodiments, the detection of a request to send (RTS) frame or a clear to send (CTS) frame may indicate the beginning of a directional link, wherein the RTS and CTS frames may also include an indication when the directional link ends and, thereafter, when the omnidirectional period is about to start.

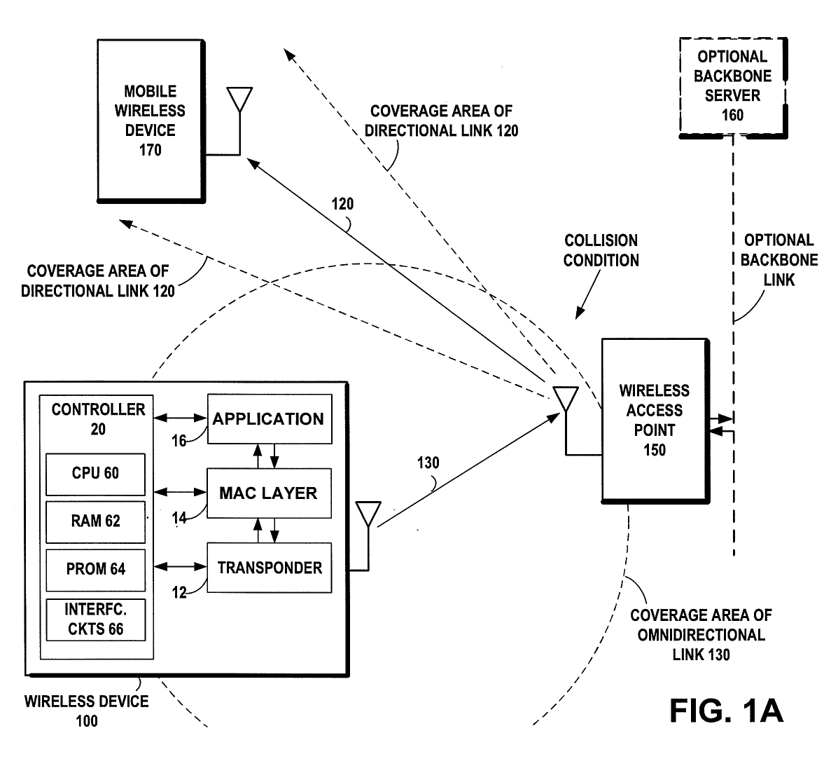

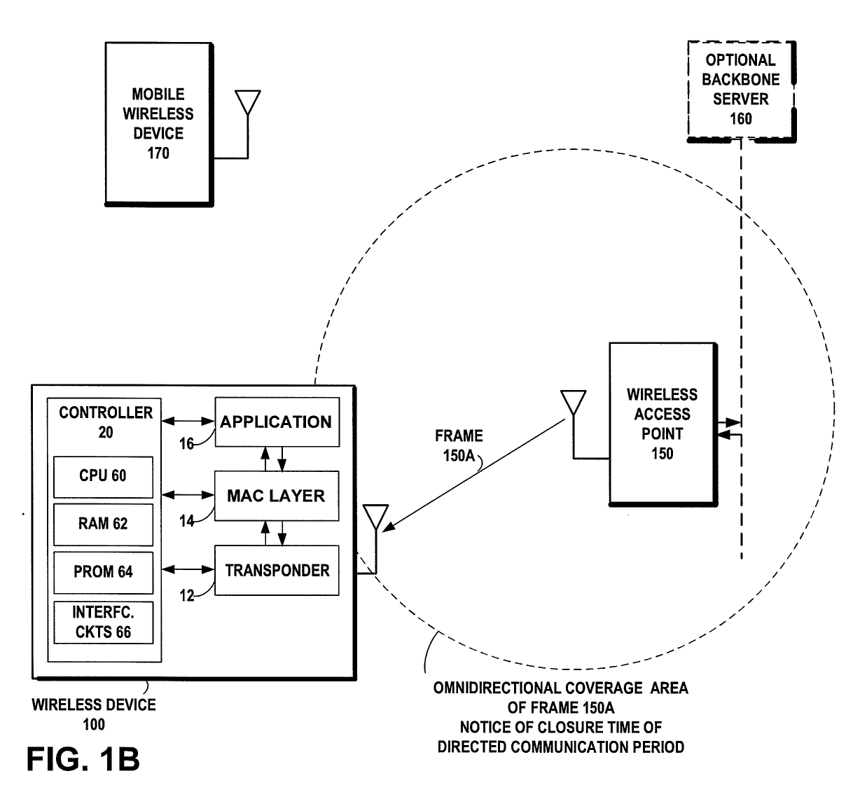

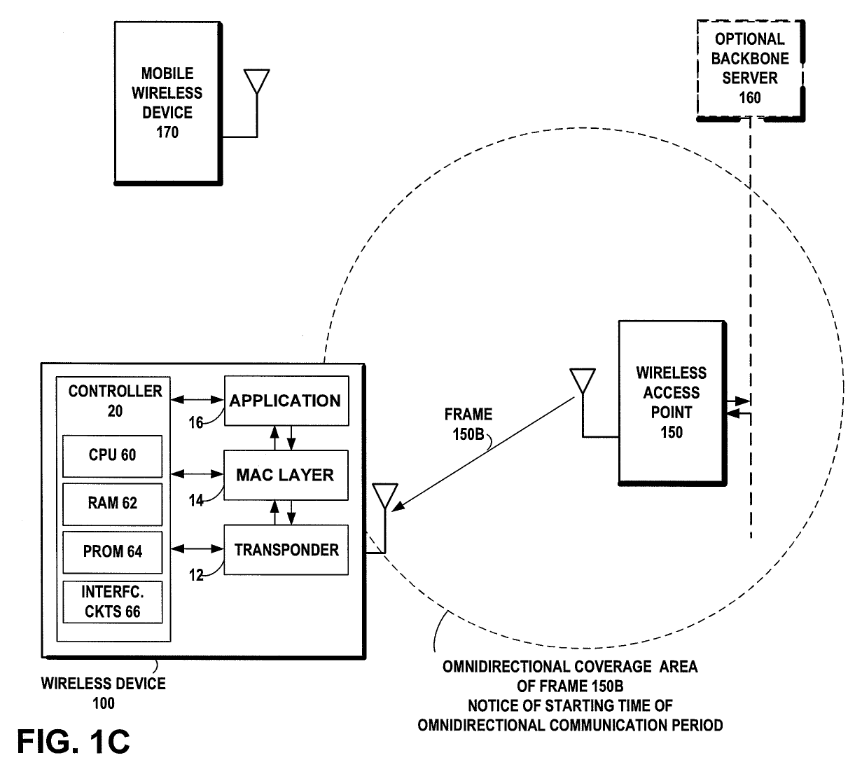

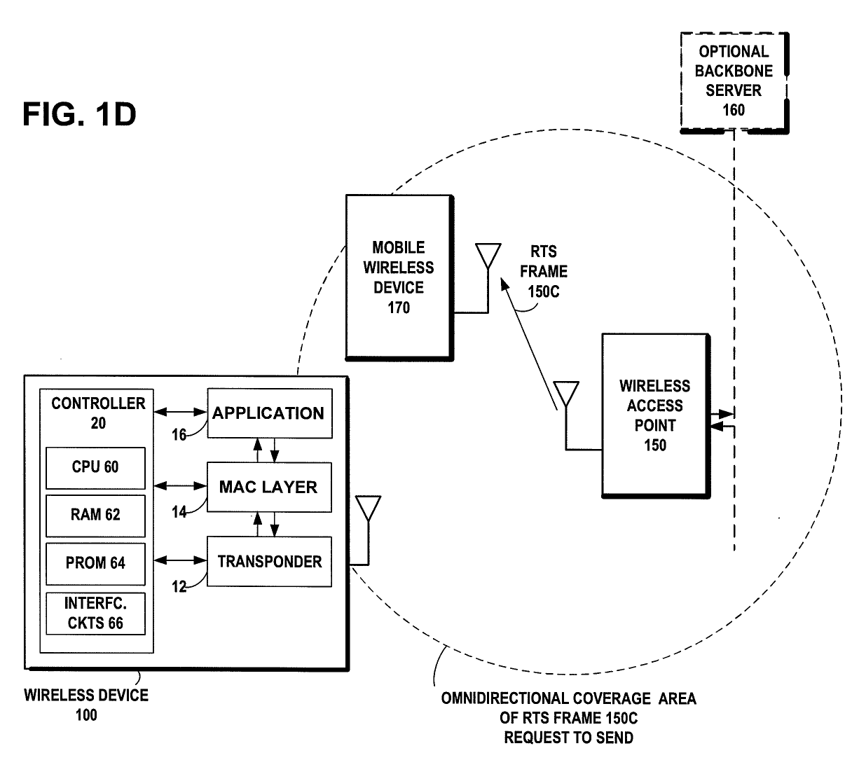

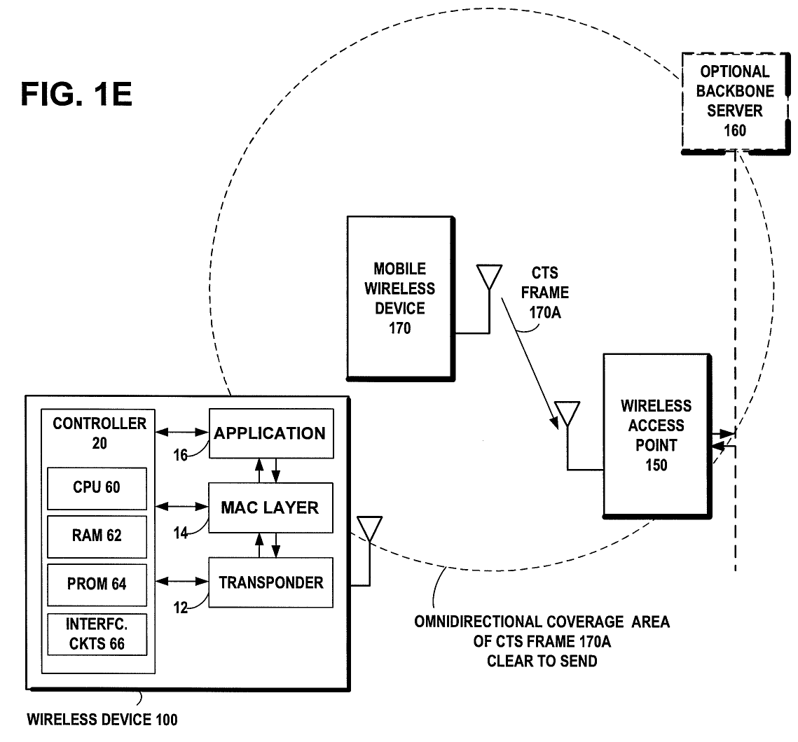

FIG. 1A illustrates an external view and a functional block diagram of an example embodiment of a mobile wireless device 100 and a wireless access point network 150, wherein the mobile device 100 does not detect the ongoing directional radiation pattern of the access point 150 in communicating over the directional link 120 with the mobile wireless device 170 and mistakenly begins omnidirectional transmission of its probe request 130, thereby causing a collision condition. The mobile wireless device 100 can be a mobile communications device, PDA, cell phone, laptop or palmtop computer, or the like. The mobile wireless device 100 may also be an integrated component of a vehicle, such as an automobile, bicycle, airplane or other mobile conveyance.

The mobile device 100 includes a control module 20, which includes a central processing unit (CPU) 60, a random access memory (RAM) 62, a read only memory (ROM) or programmable read only memory (PROM) 64, and interface circuits 66 to interface with a key pad, display, optional microphone, speakers, ear pieces, and camera or other imaging devices, etc. The RAM 62 and PROM 64 can be removable memory devices such as smart cards, Subscriber Identity Modules (SIMs), Wireless Application Protocol Identity Modules (WIMs), semiconductor memories such as a RAM, ROM, or PROM, flash memory devices, etc. The Medium Access Control (MAC) Layer 14 of the network protocol of the wireless device and/or application program 16 can be embodied as program logic stored in the RAM 62 and/or PROM 64 in the form of sequences of programmed instructions which can be executed in the CPU 60, carry out the functions of the disclosed embodiments. The program logic can be delivered to the writeable RAM, PROM, flash memory device, etc. 62 of the device 100 from a computer program product or article of manufacture in the form of computer-usable media such as resident memory devices, smart cards or other removable memory devices, or in the form of program logic transmitted over any transmitting medium which transmits such a program. Alternately, the MAC Layer 14 and/or application program 16 can be embodied as integrated circuit logic in the form of programmed logic arrays or custom designed application specific integrated circuits (ASIC). The transponder 12 in device 100 operates in accordance with the network protocol of the wireless device. The MAC layer 14 may operate using, for example the clause 17 PHY, clause 18 PHY or clause 19 PHY of the IEEE 802.11-2007 WLAN standard with an omnidirectional radiation pattern. It may also operate using the 60 GHz version of the IEEE 802.11 WLAN with a directional radiation pattern, for example the NGmS (next generation millimeter wave standard) or the VHT WLAN (very high throughput WLAN standard).

FIG. 1A further illustrates an optional backbone network for the access point 150. The access point 150 may be mobile or fixed apparatus. If the access point 150 is fixed, it may be optionally connected over the backbone link of FIG. 1A to the backbone server 160. The access point 150 may have the same type of components as are shown for the wireless device 100 in FIG. 1A. The access point 150 MAC layer 14 may operate using the 60 GHz version of the IEEE 802.11 WLAN with a directional radiation pattern, for example the NGmS (next generation millimeter wave standard) or the VHT WLAN (very high throughput WLAN standard). It may also operate using the clause 17 PHY, clause 18 PHY or clause 19 PHY of the IEEE 802.11-2007 WLAN standard with an omnidirectional radiation pattern.

In FIG. 1A, the mobile device 100 may not detect the ongoing directional radiation pattern of the access point 150 and may mistakenly begin omnidirectional transmission of its probe request 130. This increases the probability of collisions with other transmissions in the channel, both the ongoing directional radiation pattern of the access point 150 in the link 120 and any reply transmissions in the channel from the mobile wireless device 170. Moreover, since the probe requests 130 may occur when the directional access point 150 is either transmitting or receiving ongoing transmissions in the channel, the access point 150 may be unable to detect the omnidirectional probe request 130 and unable to respond to it accordingly.

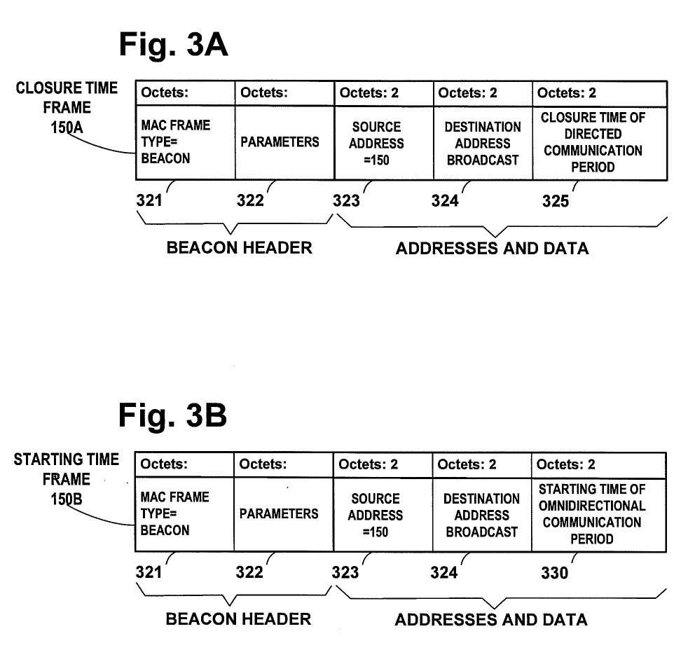

FIG. 1B illustrates the external view and functional block diagram of FIG. 1A, wherein the wireless access point 150 sends an example omnidirectional transmission of frame 150A indicating the closure time of a directed communication period. FIG. 3A is an example format for a beacon frame as the closure time frame 150A. The closure time frame 150A includes field 321 for the MAC frame type designation as a beacon frame, field 322 for parameters in the header, field 323 for the source address as the access point 150, field 324 for the destination address, which is the broadcast address, and field 325 for the closure time of directed communication period. In embodiments the frame indicating a closure time of a directional communication may be a directional beacon transmission.

In the case of FIG. 1B, the example embodiments prevent the scanning device 100 from starting omnidirectional contention for the probe request transmission until after the indicated closure time stated in field 325 of the closure time frame 150A of FIG. 3A. According to at least one example embodiment, the example scanning device 100 is not allowed to perform any access procedure until after the indicated closure time of a directional communication in the network, as per rule b). The scanning device 100 is allowed to initiate channel access procedures after the indicated closure time, i.e., after an interval following the closure time indicated in field 325. This ensures that the scanning device 100 performing active omnidirectional scanning does not create unnecessary collisions with existing directional communication links. Moreover, since the probe request transmissions are timed to occur when the directional communication link is quiescent, the wireless access point 150 in the directional network is able to detect an omnidirectional probe request transmission and respond to it accordingly.

FIG. 1C illustrates the external view and functional block diagram of FIG. 1A, wherein the wireless access point 150 sends an example omnidirectional transmission of frame 150B indicating the starting time of an omnidirectional communication period. FIG. 3B is an example format for a beacon frame as the starting time frame 150B. The starting time frame 150B includes field 321 for the MAC frame type designation as a beacon frame, field 322 for parameters in the header, field 323 for the source address as the access point 150, field 324 for the destination address, which is the broadcast address, and field 330 for the starting time of an omnidirectional communication period. In embodiments, the frame indicating a starting time of an omnidirectional communication period may be a directional beacon transmission.

In the case of FIG. 1C, the example embodiments prevent the scanning device 100 from starting omnidirectional contention for the probe request transmission until after the indicated starting time stated in field 330 of the starting time frame 150B of FIG. 3B. According to at least one example embodiment, the example scanning device 100 is not allowed to perform any access procedure until after the indicated starting time of an omnidirectional communication period in the network, as per rule c). The scanning device 100 is allowed to initiate channel access procedures after the indicated starting time, i.e., after an interval following the starting time indicated in field 330. This ensures that the scanning device 100 performing active omnidirectional scanning does not create unnecessary collisions with existing directional communication links. Moreover, since the probe request transmissions are timed to occur when the directional communication link is quiescent, the wireless access point 150 in the directional network is able to detect an omnidirectional probe request transmission and respond to it accordingly.

In example embodiments, the detection of a request to send (RTS) frame or a clear to send (CTS) frame may indicate the beginning of a directional link, wherein the RTS and CTS frames may also include an indication when the directional link ends and, thereafter, when the omnidirectional period is about to start. The RTS and CTS frames protect directional communication sequences from collisions.

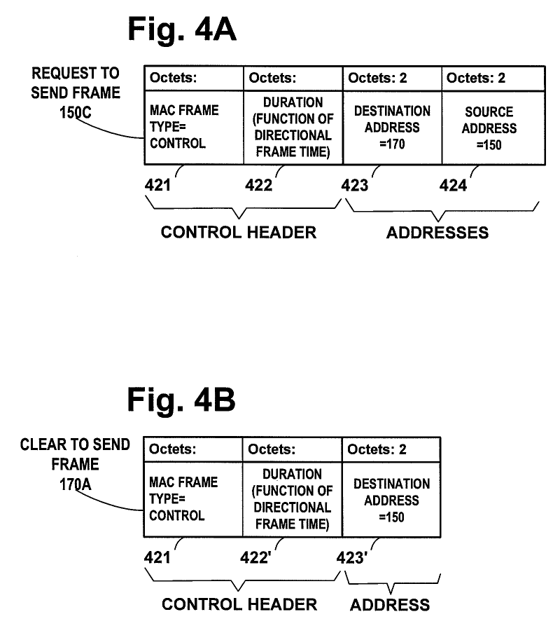

FIG. 1D illustrates the external view and functional block diagram of FIG. 1A, wherein the wireless access point sends an example omnidirectional transmission of a request to send (RTS) frame 150C indicating the duration of a frame (or a sequence of frames) it is requesting to send to the mobile wireless device 170 during a directional communication period. FIG. 4A is an example format for a control frame sent by the wireless access point as an example omnidirectional transmission of a request to send (RTS) frame 150C indicating the duration of a frame (or a sequence of frames) it is requesting to send as a directional transmission to the mobile wireless device 170 during a directional communication period. The RTS frame 150C can include a duration value that is a function of the directional frame time for the requested frame (or a sequence of frames). During the requested and granted time one can send any number of frames. The RTS frame 150C may also include an indication when the directional link ends and, thereafter, when the omnidirectional period is about to start. The request to send (RTS) frame 150C includes field 421 for the MAC frame type designation as a control frame, field 422 for the duration of a frame (or a sequence of frames) it is requesting to send, field 423 for the destination address as the mobile device 170, and field 424 for the source address as the access point 150. In example embodiments, field 422 may indicate the beginning of a directional link and/or indicate when the directional link ends and, thereafter, when the omnidirectional period is about to start. In embodiments, the RTS frame 150C may be a directional control frame transmission.

In the case of FIG. 1D, the example embodiments prevent the scanning device 100 from starting omnidirectional contention for the probe request transmission until after the indication when the directional link ends and/or thereafter, when the omnidirectional period is about to start, as stated in field 422 of the request to send (RTS) frame 150C of FIG. 4A. According to at least one example embodiment, the example scanning device 100 is not allowed to perform any access procedure until after the indication when the directional link ends and/or thereafter, when the omnidirectional period is about to start. The scanning device 100 is allowed to initiate channel access procedures after the indication when the directional link ends and/or thereafter, when the omnidirectional period is about to start, i.e., after an interval following the time indicated in field 422. This ensures that the scanning device 100 performing active omnidirectional scanning does not create unnecessary collisions with existing directional communication links. Moreover, since the probe request transmissions are timed to occur when the directional communication link is quiescent, the wireless access point 150 in the directional network is able to detect an omnidirectional probe request transmission and respond to it accordingly.

FIG. 1E illustrates the external view and functional block diagram of FIG. 1A, wherein the mobile wireless device 170 sends an example omnidirectional transmission of a clear to send (CTS) frame 170A indicating the duration of the frame (or the sequence of frames) the access point 150 has requested to send to the mobile wireless device 170 during the directional communication period. FIG. 4B is an example format for a control frame sent by the mobile wireless device 170 as an example omnidirectional transmission of a clear to send (CTS) frame 170A indicating the duration of the frame (or the sequence of frames) the access point 150 has requested to send as a directional transmission to the mobile wireless device 170 during the directional communication period. The CTS frame 170A can include a duration value that is a function of the directional frame time for the requested frame (or the sequence of frames). The CTS frame 170A may also include an indication when the directional link ends and, thereafter, when the omnidirectional period is about to start. The clear to send (CTS) frame 170A includes field 421 for the MAC frame type designation as a control frame, field 422′ for the duration of a frame (or a sequence of frames) it is clearing to be sent, and field 423′ for the destination address as the access point 150. In example embodiments, field 422′ may indicate the beginning of a directional link and/or indicate when the directional link ends and, thereafter, when the omnidirectional period is about to start. In embodiments, the CTS frame 170A may be a directional control frame transmission.

In the case of FIG. 1E, the example embodiments prevent the scanning device 100 from starting omnidirectional contention for the probe request transmission until after the indication when the directional link ends and/or thereafter, when the omnidirectional period is about to start, as stated in field 422′ of the clear to send (CTS) frame 170A of FIG. 4B. According to at least one example embodiment, the example scanning device 100 is not allowed to perform any access procedure until after the indication when the directional link ends and/or thereafter, when the omnidirectional period is about to start. The scanning device 100 is allowed to initiate channel access procedures after the indication when the directional link ends and/or thereafter, when the omnidirectional period is about to start, i.e., after an interval following the time indicated in field 422′. This ensures that the scanning device 100 performing active omnidirectional scanning does not create unnecessary collisions with existing directional communication links. Moreover, since the probe request transmissions are timed to occur when the directional communication link is quiescent, the wireless access point 150 in the directional network is able to detect an omnidirectional probe request transmission and respond to it accordingly.

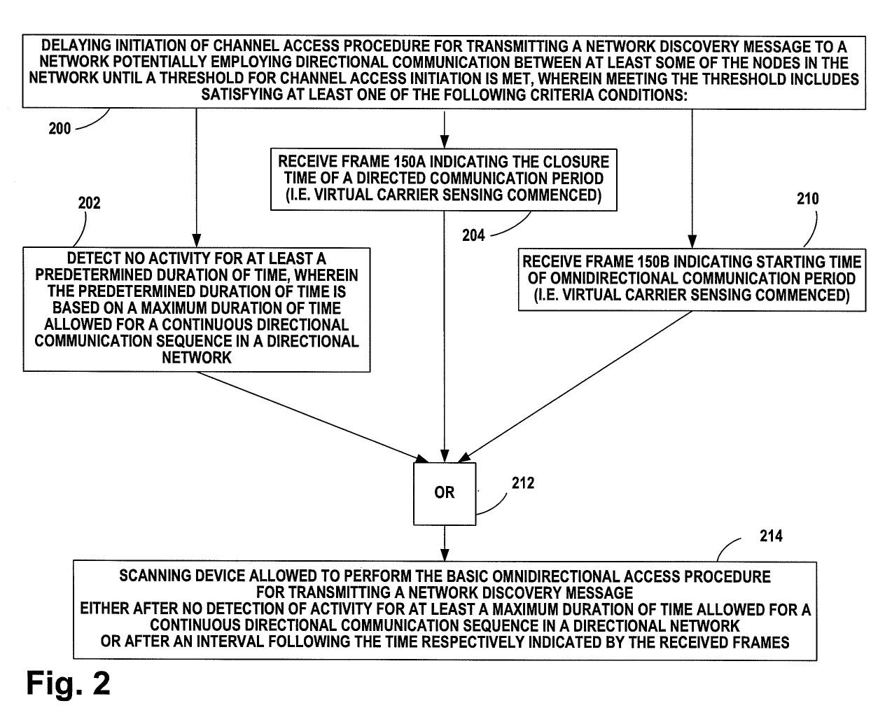

FIG. 2 is a flow diagram of an example embodiment for the mobile wireless device 100 performing an example embodiment of the active scanning procedure.

When the mobile wireless device 100, using omnidirectional radiation patterns, is about to initiate communication over a communications band that uses directional communication, e.g. the 60 GHz band, it is likely that there are networks present that are potentially employing directional communication. The example embodiments disclosed herein enable the mobile wireless device 100 to modify its operation according to the particular characteristics of the environment and implement rules that are designed for situations where directional networks are expected to be encountered. The flow diagram of FIG. 2 represents an example of rules implemented by the mobile wireless device 100 for situations where directional networks are expected to be encountered.

In step 200 of the flow diagram of FIG. 2, the example embodiments may delay initiation of channel access procedure for transmitting a network discovery message to a network potentially employing directional communication between at least some of the nodes in the network, until a threshold for channel access initiation is met. Meeting the threshold may include satisfying at least one of the following criteria steps 202, 204, or 210.

In step 202, no activity is detected for at least a predetermined duration of time, wherein the predetermined duration of time is based on a maximum duration of time allowed for a continuous directional communication sequence in a directional network.

In step 204, there is a receipt of the closure time frame 150A from the access point 150, indicating a closure time of a directional communication in the network.

In step 210, there is a receipt of the starting time frame 1 50B, indicating a starting time of an omnidirectional communication period in the network.

In step 212, an OR logical function passes on to step 214 the information as to the occurrence of one of the three above-mentioned criteria steps, 202, 204, or 210.

In step 214, the example scanning device 100 is not allowed to perform any access procedure until after the threshold is met of satisfying at least one of the criteria of steps 202, 204, or 210. For the criterion of step 202, the example scanning device 100 is not allowed to perform any access procedure until after there has been no detection of activity for at least a maximum duration of time allowed for a continuous directional communication sequence in a directional network. For the criterion of step 204, the example scanning device 100 is not allowed to perform any access procedure until after an interval following the indication in the closure time frame 150A indicating when the directional link ends. For the criterion of step 210, the example scanning device 100 is not allowed to perform any access procedure until after an interval following the indication in the starting time frame 150B indicating when the omnidirectional period is about to start.

The scanning device 100 is allowed to initiate channel access procedures after there has been no detection of activity for at least a maximum duration of time allowed for a continuous directional communication sequence in a directional network in step 202. Also, the scanning device 100 is allowed to initiate channel access procedures after the indication when the directional link ends or when the omnidirectional period is about to start, i.e., after an interval following the time respectively indicated by the received frames in steps 204 and 210.

This ensures that the scanning device 100 performing active omnidirectional scanning does not create unnecessary collisions with existing directional communication links. Moreover, since the network discovery messages are timed to occur when the directional communication link is quiescent, the wireless access point 150 in the directional network is able to detect an omnidirectional network discovery message and respond to it accordingly.

The embodiments include example frames indicating a closure time of a directed communication period or a starting time of an omnidirectional communication period. For example, the detection of a beacon transmission or a contention-free end frame may be considered as the starting point of omnidirectional communication. In example embodiments, the detection of a request to send (RTS) frame or a clear to send (CTS) frame may indicate the beginning of a directional link, wherein the RTS and CTS frames may also include an indication when the directional link ends and, thereafter, when the omnidirectional period is about to start.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than Wireless LAN networks.

What is claimed is:

1. A method, comprising:
delaying initiation of channel access procedure for transmitting a network discovery message to a network potentially employing directional communication between at least some of the nodes in the network until a threshold for channel access initiation is met, wherein meeting the threshold includes satisfying at least one of the following criteria conditions:
detecting no activity for at least a predetermined duration of time, wherein the predetermined duration of time is based on a maximum duration of time allowed for a continuous directional communication sequence in a directional network; or
receiving a frame indicating a closure time of a directional communication in the network; or
receiving a frame indicating a starting time of an omnidirectional communication period in the network;
initiating the channel access procedure for transmitting the network discovery message to the network based at least partly on the satisfied criteria condition for meeting the threshold.

2. The method of claim 1, wherein said frame indicating a starting time of an omnidirectional communication period is at least one of a beacon transmission or a contention-free end frame.

3. The method of claim 1, wherein said frame indicating a closure time of a directional communication is an omnidirectional beacon transmission.

4. The method of claim 1, wherein said frame indicating a closure time of a directional communication is a directional beacon transmission.

5. The method of claim 1, wherein said frame indicating a starting time of an omnidirectional communication period is at least one of an omnidirectional beacon transmission or a directional beacon transmission.

6. The method of claim 1, wherein said frame indicating a closure time of a directional communication is at least one of an omnidirectional request to send transmission or a directional request to send (RTS) transmission.

7. The method of claim 1, wherein said frame indicating a starting time of an omnidirectional communication period is at least one of an omnidirectional request to send (RTS) transmission or a directional request to send (RTS) transmission.

8. The method of claim 1, wherein said frame indicating a closure time of a directional communication is at least one of an omnidirectional clear to send (CTS) transmission or a directional clear to send (CTS) transmission.

9. The method of claim 1, wherein said frame indicating a starting time of an omnidirectional communication period is at least one of an omnidirectional clear to send (CTS) transmission or a directional clear to send (CTS) transmission.

10. An apparatus, comprising:
a processor configured to delay initiation of channel access procedure for transmitting a network discovery message to a network potentially employing directional communication between at least some of the nodes in the network until a threshold for channel access initiation is met, wherein meeting the threshold includes satisfying at least one of the following criteria conditions:
detecting no activity for at least a predetermined duration of time, wherein the predetermined duration of time is based on a maximum duration of time allowed for a continuous directional communication sequence in a directional network; or
receiving a frame indicating a closure time of a directional communication in the network; or
receiving a frame indicating a starting time of an omnidirectional communication period in the network;
a transceiver configured to initiate the channel access procedure for transmitting the network discovery message to the network based at least partly on the satisfied criteria condition for meeting the threshold.

11. The apparatus of claim 10, wherein said frame indicating a starting time of an omnidirectional communication period is at least one of a beacon transmission or a contention-free end frame.

12. The apparatus of claim 10, wherein said frame indicating a closure time of a directional communication is an omnidirectional beacon transmission.

13. The apparatus of claim 10, wherein said frame indicating a closure time of a directional communication is a directional beacon transmission.

14. The apparatus of claim 10, wherein said frame indicating a starting time of an omnidirectional communication period is at least one of an omnidirectional beacon transmission or a directional beacon transmission.

15. The apparatus of claim 10, wherein said frame indicating a closure time of a directional communication is at least one of an omnidirectional request to send (RTS) transmission or a directional request to send (RTS) transmission.

16. The apparatus of claim 10, wherein said frame indicating a starting time of an omnidirectional communication period is at least one of an omnidirectional request to send (RTS) transmission or a directional request to send (RTS) transmission.

17. The apparatus of claim 10, wherein said frame indicating a closure time of a directional communication is at least one of an omnidirectional clear to send (CTS) transmission or a directional clear to send (CTS) transmission.

18. The apparatus of claim 10, wherein said frame indicating a starting time of an omnidirectional communication period is at least one of an omnidirectional clear to send (CTS) transmission or a directional clear to send (CTS) transmission.

19. A computer readable medium, comprising:
a computer readable medium configured to store program instructions, which when executed by a computer processor, perform the steps of:
delaying initiation of channel access procedure for transmitting a network discovery message to a network potentially employing directional communication between at least some of the nodes in the network until a threshold for channel access initiation is met, wherein meeting the threshold includes satisfying at least one of the following criteria conditions:
detecting no activity for at least a predetermined duration of time, wherein the predetermined duration of time is based on a maximum duration of time allowed for a continuous directional communication sequence in a directional network; or
receiving a frame indicating a closure time of a directional communication in the network; or
receiving a frame indicating a starting time of an omnidirectional communication period in the network;
initiating the channel access procedure for transmitting the network discovery message to the network based at least partly on the satisfied criteria condition for meeting the threshold.

20. The computer readable medium of claim 19, wherein said frame indicating a starting time of an omnidirectional communication period is at least one of a beacon transmission or a contention-free end frame.

21. The computer readable medium of claim 19, wherein said frame indicating a closure time of a directional communication is an omnidirectional beacon transmission.

22. The computer readable medium of claim 19, wherein said frame indicating a closure time of a directional communication is a directional beacon transmission.

23. The computer readable medium of claim 19, wherein said frame indicating a starting time of an omnidirectional communication period is at least one of an omnidirectional beacon transmission or a directional beacon transmission.

24. The computer readable medium of claim 19, wherein said frame indicating a closure time of a directional communication is at least one of an omnidirectional request to send (RTS) transmission or a directional request to send (RTS) transmission.

25. The computer readable medium of claim 19, wherein said frame indicating a starting time of an omnidirectional communication period is at least one of an omnidirectional request to send (RTS) transmission or a directional request to send (RTS) transmission.

26. The computer readable medium of claim 19, wherein said frame indicating a closure time of a directional communication is at least one of an omnidirectional clear to send (CTS) transmission or a directional clear to send (CTS) transmission.

27. The computer readable medium of claim 19, wherein said frame indicating a starting time of an omnidirectional communication period is at least one of an omnidirectional clear to send (CTS) transmission or a directional clear to send (CTS) transmission.

28. An apparatus, comprising:
means for delaying initiation of channel access procedure for transmitting a network discovery message to a network potentially employing directional communication between at least some of the nodes in the network until a threshold for channel access initiation is met, wherein meeting the threshold includes satisfying at least one of the following criteria conditions:
detecting no activity for at least a predetermined duration of time, wherein the predetermined duration of time is based on a maximum duration of time allowed for a continuous directional communication sequence in a directional network; or
receiving a frame indicating a closure time of a directional communication in the network; or
receiving a frame indicating a starting time of an omnidirectional communication period in the network;
means for initiating the channel access procedure for transmitting the network discovery message to the network based at least partly on the satisfied criteria condition for meeting the threshold.
